(19) United States
(12) Patent Application Publication
(10) Pub. No.: US 2022/0145096 A1
(43) Pub. Date: May 12, 2022

(54) CERAMIC COATING WITH AMBIENT TEMPERATURE CURE

(71) Applicant: Dale Ryan, Fleming Island, FL (US)

(72) Inventor: Dale Ryan, Fleming Island, FL (US)

(21) Appl. No.: 17/583,120

(22) Filed: Jan. 24, 2022

Related U.S. Application Data
(63) Continuation-in-part of application No. PCT/US2020/042910, filed on Jul. 21, 2020.
(60) Provisional application No. 62/877,203, filed on Jul. 22, 2019.

(51) Int. Cl. C09D 5/18; C09D 7/61; C09D 133/16; C09D 161/06; B05D 7/00

(52) U.S. Cl. CPC C09D 5/18; C09D 7/61; C08K 2003/343; C09D 161/06; B05D 7/546; C09D 133/16

(57) ABSTRACT

A ceramic or composite coating is prepared from a mixture of a fire-resistant binder and an inorganic filler such that the mixture is suitable to be applied as a coating to a substrate, can be cured in situ, and protects the underlying substrate to which it is applied. In one example, the inorganic filler includes fly ash, where a mix ratio of the inorganic filler to the fire-resistant binder is from 1:1 to 9:1 by weight. The mixture can be cured in air at room temperature to form a composite coating on wood, metal, composites, and other substrates. High temperature processing can convert the composite to a ceramic.

### TECHNICAL FIELD

The present disclosure relates generally to ceramic coatings. More specifically, the present disclosure relates to a ceramic coating with an ambient temperature cure.

### BACKGROUND

Wood, metal, concrete, composites, glass, and substrates of other materials can be coated to improve resistance to rot and deterioration, for decorative purposes, and/or for functional purposes. For example, paints and lacquers can be applied to wood-based substrates to provide a specific visual appearance while also protecting the underlying substrate from moisture and sunlight. In another example, a paint or similar coating can be applied to metal substrates to protect the metal from corrosion, such as by spraying, brushing, or a powder-coating process.

Some substrates can be coated to provide a particular function. For example, metal pans can be coated with polytetrafluoroethylene (PTFE) to provide a non-stick cooking surface. Glass can be coated with an anti-reflective (AR) coating, such as on eyeglass lenses and other optics.

In addition to coatings, some substrates can be infused with chemicals to inhibit or prevent deterioration and corrosion. For example, wood can be pressure treated with a preservative, such as alkaline copper quat (ACQ), by immersing the wood in the liquid preservative and then subjecting the wet wood to high pressures to cause the preservative to soak deep into the wood. The preservative is generally toxic to insects and other organisms and therefore is useful to reduce insect damage. The preservative also adheres strongly to wood fibers to enhance the lifetime of wood that is exposed to moisture and soil.

### SUMMARY

The present disclosure relates to methodologies and compositions for protective coatings that can be applied to wood, metal, concrete, composites, and other substrates. In accordance with one embodiment, a ceramic coating adheres tenaciously to the substrate and, upon curing, hardens to a ceramic. Post-cure thermal treatment can be used to reduce or eliminate unreacted organics in the cured ceramic and/or to convert the cured ceramic to a refractory ceramic. Ceramic coatings of the present disclosure exhibit excellent fire performance, water resistance, and insect resistance, to name a few of the benefits.

### BRIEF DESCRIPTION OF THE DRAWINGS

FIG. 1 is an example X-ray diffraction spectrum for fly ash, in accordance with an embodiment of the present disclosure.

FIG. 2 is a flow chart illustrating processes in a method of coating an article, in accordance with an embodiment of the present disclosure.

FIG. 3 is a photograph of a length of wood utility pole, part of which is coated with a composite and the other part being uncoated, in accordance with an embodiment of the present disclosure.

FIG. 4 is a photograph showing the coated and uncoated sections of the utility pole of FIG. 3 after high-temperature heat processing, in accordance with an embodiment of the present disclosure.

FIG. 5 is a photograph of the coated and uncoated sections of the utility pole of FIG. 4 after removing part of the coating to reveal the underlying wood, in accordance with an embodiment of the present disclosure.

FIG. 6 is a photograph of a cured composite after exposure to a propane torch, in accordance with an embodiment of the present disclosure.

The figures depict various embodiments of the present disclosure for purposes of illustration only. Numerous variations, configurations, and other embodiments will be apparent from the following detailed discussion.

### DETAILED DESCRIPTION

The present disclosure relates to methodologies and compositions for ceramic coatings that can be applied to wood, metal, masonry, concrete, composites, and other substrates. Coating compositions can be cured while in place on the substrate, such as on a utility pole or sheet of wood-based material. The coatings can protect the underlying substrate from high temperatures, moisture, and other causes of deterioration.

### General Overview

Wood, metal, concrete, and composite substrates are widely used in construction. In one example, wooden utility poles may be treated with creosote or preservative to inhibit rot in the portion of the pole in the ground. Despite success in delaying rot with such preservatives, damage due to termites and other insects remains a significant challenge in some regions. Also, existing preservatives have little, if any, effect on the fire performance of wood-based substrates.

A wildfire typically exposes a wooden utility pole to temperatures of about 1150° C. for about two to three minutes. In this short time, the utility pole is heavily charred and rendered unsuitable for continued use. Accordingly, wooden utility poles must be replaced if exposed to a single wildfire, which may occur annually in some regions. Replacing a burned utility pole is made more expensive and more difficult due to some poles being located in remote locations that have limited or no road access. To mitigate the burden of replacing burned utility poles, it would be desirable to have a utility pole that can withstand multiple fire events in addition to having a protective coating that can inhibit or prevent water rot and insect damage.

Wood-based sheet goods are used in building construction, such as for sheathing in walls, flooring, and roof decking. Oriented strand board (“OSB”) is an engineered wood product formed by pressing together layers of wood strands and an adhesive. OSB is not suitable for exterior uses where it is exposed to weather because OSB swells when exposed to water, resulting in delamination. When water-exposed OSB is installed, the result may be ridges or humps at the seams between OSB sheets where the edge of the sheet is swollen from exposure to water. OSB that has been exposed to water may also exhibit raised areas or “blisters” on other regions of the principal faces of the sheet where the water has caused similar swelling and delamination.

In addition to degrading the appearance, water-damaged OSB has compromised structural integrity, including along edges where fasteners are often installed to secure the sheet to the underlying structural member. For these reasons, a bundle of OSB sheets (˜60-80 sheets) may be covered with a water-impervious material to protect the OSB from water between delivery at a job site and installation on the structure. Further, after installation on a structure, the outside surface of the structure is often wrapped with a moisture barrier, such as in Tyvek® wrap or similar material. Wrapping a structure with a moisture barrier is time consuming, expensive, and a generally undesirable task. Despite using best efforts to protect OSB from water, construction delays or bad luck may still result in sheets of OSB becoming wet with rain.

To address water damage to OSB sheets, one approach has been to add a layer of polymer material on one surface of the OSB sheet during manufacture. The combination of the coated surface and a sealing tape applied to seams after installation provides a water-resistive barrier that eliminates the need to wrap the structure with a moisture barrier. Although this approach may have improved water resistance, the approach has greatly increased the cost each OSB sheet and has little, if any, effect on fire performance.

The existing approaches to inhibiting rot and water damage in wood-based construction products have been useful in some regards, but many challenges remain. Additionally, approaches to prevent rot and water intrusion generally do not improve fire performance. For example, chemical treatment to wood products generally has little, if any, effect on fire performance. Further, existing approaches do not adequately prevent damage from some insects, such as termites. Accordingly, a need exists for improvements to protective coatings for wood-based materials and other substrates.

The present disclosure addresses this need and others by providing ceramic coating compositions that are suitable for coating a substrate, such as sheets of wood or poles, can be cured in situ after being applied to the substrate, and that can protect the substrate from fire, water, ultraviolet light (UV), impact and abrasion, mold, and/or insects.

In accordance with some embodiments, a pre-cure mixture includes a fire-resistant epoxy or resin binder and an inorganic filler mixed with a mix ratio of filler to binder from 1:1 to 9:1 by weight. For example, the binder can be brominated polyester resin, brominated vinyl ester resin, brominated epoxy, or phenolic resin and the filler can comprise class C fly ash. After mixing the resin and fly ash, an initiator is added to the mixture to initiate polymerization. Initiators can be selected based on the specific polymer system that is used. The mixture cures to a composite that includes a continuous phase of an organic polymer matrix and a dispersed phase of inorganic filler. Curing the composite occurs within a gel time dictated at least in part by the mix ratio, quantity of initiator, and temperature.

Prior to expiration of the gel time, the catalyzed mixture can be extruded, rolled on, brushed on, sprayed, or otherwise applied to the surface of a substrate and then allowed to cure at ambient temperature to a composite coating that is bound to the surface of the substrate. Post-cure thermal treatment (e.g., 100° C.-200° C.) optionally can be used to further cure the composite and convert it to a ceramic by reducing unreacted organics. In some embodiments, the cured composite can also be heated to temperatures of 850° C. or more to convert it to a refractory ceramic. For example, exposing the cured composite in situ to temperatures of 1000-1150° C. for 2-3 minutes converts the mixture to a refractory ceramic coating that has a very low coefficient of thermal conductivity (˜0.1-0.4 W/mK at 25° C.) and that protects the underlying substrate when exposed to fire.

In addition to fire performance, the composite or ceramic coating has shown to be effective to block water intrusion, corrosion, and insects. Further, since fly ash is waste product with little or no cost, the composite or ceramic coatings can be applied economically to wood-based sheet goods (e.g., oriented strand board (OSB) sheets), utility poles, metal, and other substrates. Optionally, additional fillers or additives can be added to the mixture to enhance performance in one or more criteria, such as fire performance, pliability, cure time, abrasion resistance, impact or ballistic resistance, color, UV stability, or other property of the coating. Numerous variations and embodiments will be apparent in light of the present disclosure.

Coating compositions according to the present disclosure can be detected by analyzing the pre-cure mixture, the composite after curing at room temperature, or the cured ceramic after post-cure heat treatment (e.g., to 850° or more). For example, X-ray diffraction (XRD), X-ray fluorescence (XRF), energy dispersive X-ray analysis (EDXA), scanning electron microscopy (SEM), transmission electron microscopy (TEM), thermogravimetric analysis (TGA), and mass spectrometry are examples of some analytical techniques. In one example, EDXA can be used to determine the elemental composition of a sample, and therefore, the presence of fly ash and/or its equivalent chemical elements. Additionally, TEM can be used to assess morphology and structure of a sample. XRF can be used to evaluate the bulk oxide content, and EDXA can be used to determine specific elements present in a sample. Further, the presence of unreacted styrene can be detected to indicate the use of a polyester or vinyl ester resin binder. Scanning electron microscopy can be used to determine particle sizes, size distributions, and material boundaries. Rockwell hardness can be measured using ASTM E18.

Compositions in accordance with the present disclosure can be used as a protective coating for wood, composites, metal, masonry, and other substrates. Additionally, the compositions can be formed into stand-alone composite or ceramic products, such as roofing shingles, tiles, heat shields, spacers, and other products used in applications requiring resistance to heat, water, corrosion, UV light, and insects, for example. In these and other cases the material can be extruded or molded in addition to coating. Numerous variations and embodiments will be apparent in light of the present disclosure.

Materials that are “compositionally different” or “compositionally distinct” as used herein refers to two materials that have different chemical compositions. This compositional difference may be, for instance, by virtue of an element that is in one material but not the other (e.g., SiO₂ is compositionally distinct from SiOH), or by way of one material having all the same elements as a second material but at least one of those elements is intentionally provided at a different concentration in one material relative to the other material. In addition to such chemical composition diversity, the materials may also have distinct impurities (e.g., trace metals) or the same impurities but at differing concentrations.

Coating Compositions and their Applications

In accordance with one embodiment, a coating adheres tenaciously to the substrate and, upon curing, hardens to a composite having a polymer matrix with inorganic filler dispersed in the matrix. Post-cure thermal treatment can be used to reduce or eliminate unreacted organics in the cured composite and/or to convert the composite to a refractory ceramic. Ceramic and composite coatings of the present disclosure have shown experimentally to have excellent fire performance, water resistance, and insect resistance, to name a few of the benefits.

In accordance with some embodiments, the cured composite originates from a mixture of an inorganic filler and a fire-retardant resin or epoxy. The mixture has physical properties suitable for coating a substrate, can be cured in situ on the substrate, and functions as a protective coating when cured. In accordance with some embodiments, the inorganic filler is mixed with the resin binder at a mix ratio of filler to binder of 1:1 to 9:1 by weight, including ratios of 1.2, 1.5, 1.8, 2.0, 2.5, 3.0, 3.5, 4, 5, 6, 7, 8, and ranges between any two of these values. In various embodiments the mix ratio of filler to binder can be, for example, less than 10:1, less than 5:1, less than 2:1, greater than 0.1:1, greater than 0.5:1, greater than 1:1, greater than 2:1, or greater than 5:1. An oxidizing initiator is added to the mixture (e.g., ˜1-3% by weight) and the mixture then can be cured in air at room temperature or low heat to a hardened composite.

In one example, the initiator is a peroxide, such as methyl ethyl ketone peroxide (MEKP) or benzoyl peroxide, added at about 1.75% by weight of the resin. Without being constrained to any particular theory, it is believed that these initiators utilize free radical polymerization to cure the resin. Prior to curing, the initiated mixture can be applied to the substrate by brushing, spraying, rolling, extruding, dipping, or other coating method. The applied mixture can be cured at room temperature or with heat in situ. The mix ratio of filler to resin, the cure temperature, and quantity of initiator can be selected to provide a pre-cure viscosity that is suitable for the intended coating method, prevents settling of filler, and provides a gel time appropriate for the substrate to be coated and the coating method. For example, the coating binds to the substrate by wetting the surface. Thus, the surface roughness and porosity of the substrate may also be a factor in determining the appropriate viscosity of the pre-cure or initiated mixture.

In one example, the fire-retardant binder is a halogenated pre-polymer. For example, the binder can be a brominated vinyl ester resin, a brominated polyester resin, a phenolic resin, or a brominated epoxy. Other acceptable binders include aliphatic resin, latex, polyurethane, and a sugar-based epoxy resin. Such binders are commercially available. An example of one such binder is 4510 brominated vinyl ester resin available from AOC Resins of Collierville, Tenn.

Other binders may be utilized, and coating compositions of the present disclosure are not limited to those listed above. In some cases, a particular binder has a significant impact on the final cost of the formulation, so the binder may be selected at least in part based on the commercial viability of the coating (e.g., cost, availability). For high-volume coating operations and products with acute cost sensitivity, such as sheets of oriented strand board (OSB), a lower-cost binder can be selected. In some instances, the cost of the coating formulation can be further reduced by increasing the mix ratio of filler to binder.

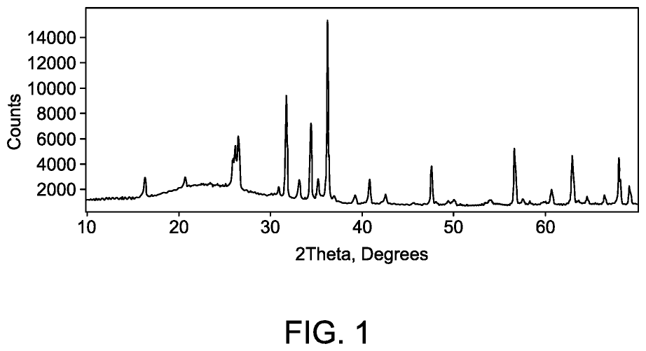

In one example, the filler is class C fly ash from Pennsylvania. Class C fly ash from other locations, class F fly ash, bottom ash, lignite, kaolin, bottom ash, lignite, and mixtures thereof can also be used. Fly ash is defined by the US Environmental Protection Agency as “the residuum from the burning of a combination of carbonaceous materials and may contain oxides of aluminum, calcium, iron, magnesium, nickel, phosphorous, potassium, silicon, sulfur, titanium, and vanadium. FIG. 1 is an example of an XRD spectrum of a fly ash powder believed to be derived from coal from central Texas, in accordance with one embodiment. An XRD spectrum can be used to determine relative quantities of oxides present in the fly ash. The counts (y-axis value) may vary among different fly ash samples, as will be appreciated. A similar analysis can be performed on cured compositions.

Fly ash of all types generally has the following composition:

TABLE 1

| Fly Ash-general | % (w/w) |
|---|---|
| Amorphous calcium- | 70-90 |
| aluminum silicates | |
| Crystalline silica (SiO₂) | <16 |
| Calcium oxide (CaO) | <30 |
| Potassium oxide | 1-5 |
| Phosphorous pentoxide | <2 |

Class C fly ash from subbituminous coal generally has the following composition:

TABLE 2

| Class C Fly Ash | % (w/w) |
|---|---|
| Silica (SiO₂) | 40-60 |
| Aluminum Oxide (Al₂O₃) | 20-30 |
| Iron oxide (Fe₂O₃) | 4-10 |
| Calcium Oxide (CaO) | 5-30 |
| Loss on Ignition | 0-3 |

Class C fly ash from lignite generally has the following composition:

TABLE 3

| Class C Fly Ash | % (w/w) |
|---|---|
| Silica (SiO₂) | 15-45 |
| Aluminum Oxide (Al₂O₃) | 20-25 |
| Iron oxide (Fe₂O₃) | 4-15 |
| Calcium Oxide (CaO) | 15-40 |
| Loss on Ignition | 0-5 |

Class F fly ash from bituminous coal generally has the following composition:

TABLE 4

| Class F Fly Ash | % (w/w) |
|---|---|
| Silica (SiO₂) | 20-60 |
| Aluminum Oxide (Al₂O₃) | 5-35 |
| Iron oxide (Fe₂O₃) | 10-40 |
| Calcium Oxide (CaO) | 1-12 |
| Loss on Ignition | 0-15 |

Fly ash particles can have a spherical shape and a particle size range from 0.5 μm to 300 μm, in accordance with some embodiments. The particular fly ash can be selected to provide the desired chemical composition and properties, such as pH, presence or absence of trace metals, and being self-cementing, for example.

Optional additives can be added to the inorganic filler (e.g., fly ash). Examples of additives include talc, kaolin, mullite, and bottom ash. For example, it may be desirable for sheets of coated OSB to be fire resistant, water resistant, and resistant to abrasion, while also being cost competitive to alternative construction materials. Additives can be selected to enhance one or more performance criteria, such as fire performance, waterproofing, impact resistance, abrasion resistance, surface modification, weight modification, increased bond strength to the substrate, UV stability, and/or resistance to insects and biologics. Additives can be added alone or in combination with other additives of a similar or different type of performance.

In some embodiments, a particular additive may be selected based on a cost-benefit analysis. In other embodiments, such as where performance is the overriding concern, an additive may be used despite its high cost, as will be appreciated. Additives can be added up to 40% by weight of the mixture, in accordance with some embodiments. Optionally, a higher additive concentration can be used, such as to achieve a particular performance goal. In one example the inorganic binder is a blend of class C fly ash and kaolin, where the fly ash is present from 40-95% by weight, including, 45%, 50%, 55%, 60%, 65%, 70%, 75%, 80%, 85%, 90%, and ranges between any two of these values. In another example, the inorganic filler includes 50-60% fly ash, 30-50% kaolin, and 5-20% mullite by weight. Numerous variations and embodiments will be apparent in light of the present disclosure. In yet another example, the inorganic filler is at least 90%, at least 95%, or at least 98% fly ash by weight.

Examples of fire performance additives include alumina tri-hydrate, calcined brown fused alumina, kaolin platelets, silicon carbide (black or green), ceramic foundry sand, hollow glass microspheres, and mullite powder.

Kaolin (also referred to as kaolinite) is a clay mineral with the chemical composition Al₂Si₂Os(OH)₄ or Al₂O₃.2SiO₂.2H₂O. Kaolin powder has a firing temperature of 1150° C. and can be added to enhance fire performance. Additionally, when the cured composite coating is subjected to the firing temperature (1150° C.), the mixture containing kaolin has been observed to produce a surface char layer, which is believed to be burned binder. Underlying portions of the coating may be converted at high temperature to a refractory ceramic.

Mullite (also referred to as porcelainite) has a chemical formula of 3Al₂O₃.2SiO₂ or 2Al₂O₃.SiO₂. Mullite is a silicate mineral that has a melting point of 1840° C. Mullite can be added to the filler to enhance high-temperature performance. For example, mullite can be added to compositions having an intended use in aerospace and other high-temperature applications.

Examples of additives for enhanced impact resistance (ballistics) and/or abrasion resistance include glass fibers, Kevlar fibers, carbon fibers, granite powder, laminated glass, acrylic pellets, polycarbonate powder, artificial diamond powder, zirconium silicate, and steel shot. Coating compositions with or without these additives can be used as an adhesive between layers of a laminated veneer lumber (LVL), such as a railroad tie or bridge trestle beam. The coating with additives for abrasion resistance can additionally be applied to the outside surface of the LVL member.

Adhesion modifiers include silane, fused silica, mullite needles, and micro silica. In one example, using one or more such additive can result in a surface of the cured ceramic that resists adhesion by foreign bodies, such as spray paint and barnacles.

Although the mixture of fly ash and binder appears to have inherent UV-blocking properties, the UV resistance can be enhanced when the coating is to be used with dyes and other color additives. For example, metal oxide powders can be added to enhance UV light stability of dyes in the coating mixture.

Examples of weight modifiers include hollow rice hulls, fumed silica, hollow glass spheres, gas or liquid bubbles and foam powders. These additives can be added to lower the density of the cured composite, in accordance with some embodiments.

Additives may also be selected to enhance adhesion between the coating and the substrate. One such additive is rice hull ash (RHC). Other additives that have been found to enhance adhesion to the substrate include fumed silica, and silicon carbide. These additives enhance the bond between the resin and the filler, as well as between the ceramic coating and the substrate.

The base mixture can be made by placing the resin binder in a suitable container. The inorganic filler and additives (if any) are weighed and placed in the container with the binder. In many embodiments the inorganic filler need not be ground, sieved and/or washed prior to use. The ratio of binder to filler components can be determined based on a balance of performance and cost. A suitable mixing device such as a “Henschel” high-shear mixer is then activated to thoroughly mix the liquid mixture. The mixture is moved to the proper application machine where it is catalyzed by an oxidation initiator such as, but not limited to, methyl ethyl ketone peroxide, benzoyl peroxide, or other initiators having a suitable cure time. The initiated material is then applied to the substrate and the coated article can be cured in air at room temperature. In some embodiments, curing is performed by passing the coated article beneath heaters or through a low-temperature furnace (˜130° C.) to more rapidly and/or more completely cure the material.

The pre-cure mixture can be applied to a substrate with a layer thickness of 0.125-0.25 inch (˜3-6 mm), in accordance with some embodiments. The coating is not limited to these thicknesses and greater or smaller thicknesses can be used as needed, including 0.5 mm, 1 mm, 2 mm, 7 mm, 8 mm, 9 mm, 10 mm, and ranges between these values.

In some embodiments, a plurality of coating layers can be applied to the substrate. In one such embodiment, a first layer of the pre-cure mixture is applied with a thickness of 1-6 mm and allowed to cure to a composite or ceramic. A second layer of a second pre-cure mixture is applied over the cured first layer and has a second layer thickness of 1-6 mm. The first layer and the second layer (and/or third, fourth . . . ) can be of the same or different composition. In one example, the first layer is class C fly ash and brominated vinyl ester resin with a mix ratio of 3:1. The second layer is kaolin and brominated vinyl ester resin with a mix ratio of 1.2:1. In other examples, two, three or more layers of the same composition can be applied, where each layer is cured at least to a hardened composite prior to applying the next layer.

Application methods include, brushing, rolling, or spreading the coating mixture onto the substrate; dipping the substrate into the coating mixture; and extruding the coating mixture, to provide a few examples. In one embodiment, a die extruder provides a ribbon of initiated mixture having a width of approximately 8 inches (20 cm) and a thickness of ⅛″ (˜3 mm). This ribbon can be wrapped in a spiral around a wooden utility pole in partially overlapping layers to coat the entire outside surface of the pole. The rotation of the utility pole can also help to prevent sagging of the mixture. In some embodiments, edges of the extruded material have a reduced thickness (e.g., a thickness of about 1/16″ or 1.5 mm thick) so that the applied coating has about the same thickness in overlapping regions and non-overlapping regions as applied.

In another example, a slot die extruder is used to provide a ribbon of the initiated mixture having a width of about 48 inches (˜122 cm). This wide ribbon of initiated material can be applied to sheet goods, such as the principal face of a sheet of OSB. After applying the initiated material, the material is cured in air or inert atmosphere at a temperature from 5° C. to 200° C., such as room temperature (25° C.), to result in a cured composite. In one example, coating the OSB and curing the applied coating are performed in a rapid process in which uncoated OSB is moved by a conveyor and coated using the die extruder. After coating the sheet, the OSB passes through a heat tunnel with an oxygen-free atmosphere to rapidly cure the composite. Depending on the temperature used, the curing process may result in a ceramic coating. The OSB sheets coated with composite or ceramic can now be handled and stacked.

Low temperature post-cure heat treatment is an optional process that may be used to alter the physical properties and chemical makeup of the cured composite. In one example, the cured composite is heated to a temperature from 100-200° C. to expedite curing. This processing can also remove at least some of the unreacted organics (e.g., styrene). In one such example, the resulting heat-treated cured composite may become a more rigid composite compared to the room-temperature-cured composite, yet still retains the polymer matrix phase and the distributed inorganic filler phase. The composite can also can become harder.

High temperature post-cure heat treatment is another optional process. In one embodiment, the cured composite is heated to a temperature of at least 800° C., including at least 850° C., at least 900° C., at least 950° C., at least 1000° C., at least 1050° C., at least 1100° C. and at least 1150° C. Post-cure heating can be performed in air, in an oxidizing atmosphere, an inert atmosphere, or a reducing atmosphere, depending on the binder. For example, when the binder is vinyl ester resin, an inert, reducing, or other atmosphere free of oxygen is preferred.

Post-cure heating can be performed for a time sufficient to remove all or substantially all of the organics in the cured ceramic, leaving no organics or only trace amounts of organics and resulting in a ceramic coating. Depending on the temperature selected, the ceramic may undergo a partial phase change during post-cure heating. For example, the temperature of post-cure heating is sufficient to convert the ceramic to a refractory ceramic. Post-cure heating can occur during manufacture of a coated article, in some embodiments. In the case of a utility pole, for example, post-cure heating can occur during a wildfire where temperatures typically reach 2100° F./1150° C. for a period of 2-3 minutes. During such time, the heat is sufficient to create a surface char layer of burned resin on the ceramic coating where underlying portions of the substrate remain unchanged or substantially unchanged. In some embodiments, post-cure heat treatment may be referred to as sintering or firing, depending on the temperature used and melting point of the composition, as will be appreciated.

Ceramic and composite coatings according to the present disclosure can be applied to protect various substrates from fire, water, corrosion, UV exposure, abrasion, impact (ballistics), insect damage, and mold. Due to the use of postindustrial components, the resulting ceramic can be cured at room temperature in situ with a very low cost.

Several methods for application of the coating material to various substrates have been successfully utilized. Some methods are more laborious and have been used for manufacturing test prototypes. Some methods have been evaluated for high-speed applications, such as for dimensioned lumber and sheet goods.

Roll coating can be used on sheet goods, such as plywood, medium density fiberboard (MDF), or oriented strand board (OSB). Roll coating can be used coat the large area of such substrates at very fast rates. For example, the pre-cure ceramic material (in liquid form) can be applied to rollers which then apply the liquid material to a face of the sheet. The sheet can then be passed through a heat tunnel where the composite is quickly cured and ready for handling and stacking.

Die coating or extrusion is a coating process that is useful for dimensional lumber, such as framing studs, posts, boards, and the like. In one example, the lumber is a 2″×4″ (˜50 mm×100 mm) kiln-dried pine stud with actual dimensions of about 1.5″×3.5″ (˜38 mm×89 mm). The lumber was coated by pushing it through a die to coat the long exterior surfaces (not ends) with a one-sixteenth inch thick (˜1.5 mm) layer of composite material. The coated stud was allowed to cure in air at room temperature. Other lumber could be similarly coated, such as boards with a cross-sectional dimension of 2″×6″ (˜50 mm×150 mm), 2″×8″ (˜50 mm×200 mm), 2″×10″ (˜50 mm×250 mm), 1″×4″ (˜25 mm×100 mm), 1″×6″ (˜25 mm×150 mm), 4″×4″ (˜100 mm×100 mm), 6″×6″ (˜150 mm×150 mm) and other sizes of boards of any length. Die coating has shown to be very fast and continuous process for studs, boards, posts, and the like. In some embodiments, a slot die can be used to produce a ribbon of initiated pre-cure material that can be applied to the face of sheet goods or wrapped around cylindrical objects such as a utility pole.

Spray coating, electrostatic coating, and injection molding are techniques that can be used for coating odd-shaped components such as bicycle frames and steel rebar. Spray coating is fast and conserves material but may require equipment that confines the spray action. Articles with irregular shapes can also be coated using an electrostatic coating method. Injection molding is another rapid coating method suitable for coating odd-shaped parts, such as automotive parts.

### Method of Coating:

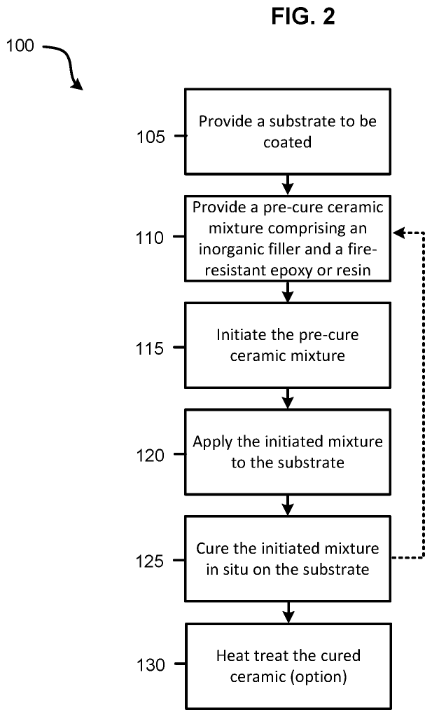

FIG. 2 is a flow chart showing processes in a method 100 of coating a substrate, in accordance with some embodiments. In block 105, a substrate to be coated is provided. In one embodiment, the substrate comprises wood or is a wood-based product. For example, the substrate is a wooden utility pole, dimensioned lumber, or a sheet of MDF, OSB, or plywood. In other embodiments, the substrate is or includes metal, such as a length of rebar, a rebar structure, or a bicycle frame.

In block 110, a pre-cure ceramic mixture is provided, where the mixture comprises an inorganic filler and a fire-resistant epoxy or resin. In some embodiments, the inorganic filler includes fly ash, such as class C fly ash, as a majority component. For example, class C fly ash is 60%-100% by weight of the inorganic filler. In other embodiments, the inorganic filler includes kaolin or additives up to 40% by weight. In yet another embodiment, the inorganic filler consists essentially of fly ash. Numerous mixtures can be used, as discussed in more detail above. The mix ratio can be adjusted as desired to provide a viscosity suitable to wet the substrate's surface and suitable for the application method, such as roll-coating, extruding, or other method. The fire-resistant epoxy or resin can be, for example, brominated vinyl ester resin, brominated polyester resin, brominated epoxy, or phenolic resin. Other halogens can be used for fire resistance. In some embodiments, the mixture has a mix ratio of filler to binder from 1:1 to 9:1, including about 2:1, about 3:1, about 4:1, and about 6:1.

In block 115, the pre-cure mixture is initiated by admixing an oxidizing initiator, such as methyl ethyl ketone peroxide (MEKP) or benzoyl peroxide. In one embodiment, the initiator is added in an amount from about 1.5% to about 3% by weight of resin and mixed thoroughly. Mixing can be performed by hand, using a mixing machine, or using a screw drive or auger-type mixer, for example. The amount of the initiator can be selected as desired to adjust the gel time of the ceramic, and, to some extent, to adjust the viscosity of the initiated mixture, as will be appreciated. In some embodiments, the initiator can be admixed with the binder and filler, such as when the mix ratio is high and including the initiator facilitates mixing.

In block 120, the initiated mixture is applied to the surface of the substrate so as to wet the surface. By wetting the surface, the cured ceramic intimately contacts the surface so that the cured ceramic can bind firmly to the substrate, in accordance with some embodiments. The initiated mixture can be applied by roll coating, brushing onto the substrate, dipping, extruding, spraying or other methods, such as discussed in more detail above. In some embodiments, the initiated mixture is applied with a layer thickness from 1 mm to 10 mm, including 2 mm, 3 mm, 4 mm, 5 mm, 6 mm, 7 mm, 8 mm and 9 mm. As noted above, the viscosity of the initiated mixture can be adjusted to suit the application method, as will be appreciated. For example, when extruding the mixture, it may be desirable for the mixture to have a paste-like consistency, such as having a viscosity on the order of 2E6 cP. For spraying or roll-coating, the viscosity should be lower so that the mixture is flowable, such as 100 cP or 1 cP. In various embodiments, the viscosity of the uncured mixture can be greater than 100, greater than 1000, greater than 10,000, greater than 100,000 or greater than 1,000,000 cP. In other embodiments, the viscosity can be less than 1,000,000, less than 100,000, less than 10,000 or less than 1,000 cP.

In block 125, the applied mixture is cured in situ to form a composite coating on the substrate. In some embodiments, the mixture is cured at room temperature in air. In other embodiments, the mixture is cured to a hardened composite at an elevated temperature (e.g., 100-200° C. in an oxygen-free atmosphere). Cure time can be less than one day, less than 6 hours, less than 1 hour, greater than 1 hour, greater than 24 hours or greater than 10 days.

Optionally, method 100 returns to block 110 to provide an additional (second, third, fourth, . . . ) pre-cure coating mixture, initiating the additional mixture at block 115, and applying the additional mixture on the previous cured composite layer. In some embodiments, the subsequent pre-cure mixture is compositionally distinct from the previous pre-cure mixture. For example, the first mixture includes fly ash as the majority component of the filler and the second mixture includes kaolin as the majority component of the filler. In other embodiments, the additional pre-cure mixture is the same as the first or previous pre-cure mixture. In many cases, the previously applied layer needs no treatment or intermediate adhesive in order to successfully adhere to the next layer.

In block 130, the cured composite is optionally heat treated to remove organics. In some embodiments, heat treating can be performed at a temperature of 100-300° C., for example, to drive off unreacted organics from the cured ceramic, such as styrenes, phenols, and formaldehydes. In other embodiments, heat-treating is performed at a temperature of 850° C. or greater to remove all or substantially all of the organics and convert the composite to a ceramic. In some embodiments, the heat treating is a sintering process. In other embodiments, the heat treating is a firing process. In some embodiments, the result of heat treating is a refractory ceramic.

The process flow of FIG. 2 and the foregoing discussion is provided as an example of one embodiment of method 100. Numerous variations and embodiments will be apparent in light of the present disclosure.

### Example Compositions and Experimental Results

Example 1: a brominated vinyl ester resin was mixed with class C fly ash to form a pre-cure mixture with a mix ratio of filler to binder of about 3:1 by weight. Rheology testing indicates that the pre-cure mixture is shear-sensitive. The binder is a commercially available brominated vinyl ester resin. After mixing the binder and filler by hand or using a motorized mixer, methyl ethyl ketone peroxide (DDM-9 MEKP, available commercially) was added to the mixture at 1.75% of the composition by weight of the binder, resulting in a gel time of about 35 minutes for the initiated mixture. The initiated mixture was then poured into a mold and allowed to cure in air for two days. Note that increasing the MEKP to 3.0% by weight of the binder reduced the gel time to about 14 minutes at room temperature. Samples of the cured composite were heat treated for two hours at 120° C., then subjected to thermogravimetric analysis (TGA) by heating at 10° C./min in air to 990° C. TGA analysis resulted in a mass loss of about 25%.

Resin: 254.1 g

Class C fly ash: 760.1 g

MEKP Initiator: 4.45 g

Gel time ˜35 minutes at room temperature

Viscosity: high (slow flow, but flowable)

Thermal conductivity (RT cured): 0.34 W/mK at 25° C.

Thermal conductivity (after post-cure bake at 500° C.): 0.15 W/mK at 25° C.

Glass transition temperature: 97° C.

Modulus: 10,700 MPa at 25° C.

Example 2: brominated vinyl ester resin and kaolin powder were mixed at a mix ratio of kaolin to binder of 1.18:1. Rheology testing indicates that the pre-cure mixture is shear-sensitive. DDM-9 MEKP initiator was added to the pre-cure mixture at 1.75% by weight and mixed thoroughly, yielding a gel time of more than 120 minutes. A cast film was prepared and allowed to cure in air at room temperature for two days. A second set of samples were placed into a mold using putty knife, cured in air at room temperature for two days, and then heat treated at 120° C. for two hours in air. Samples from the second set were subjected to thermogravimetric decomposition analysis (TGA) by heating at 10° C./min in air to 990° C. TGA analysis resulted in a mass loss of about 6.5%.

Resin: 147.2 g

Kaolin: 174.2 g

Initiator: 2.6 g

Gel time: ˜150 minutes

Viscosity: greater than 1,000,000 cP, very high (paste-like, not flowable)

In variations on Example 2, it was observed that increasing the mix ratio of filler to binder resulted in a non-flowable mixture of high viscosity that could not be mixed by hand.

Example 3: brominated vinyl ester resin and kaolin were mixed at a filler to binder mix ratio of 2:1 to form a pre-cure mixture. Rheology testing indicates that the pre-cure mixture is shear-sensitive. The resulting mixture was not flowable. Initiator was then added to the mixture at 2.6% by weight of the binder and the composition was thoroughly mixed. The initiated mixture was applied to a mold using a putty knife and pressed between mold plates to create a plaque of uniform thickness. Samples were heat treated for two hours at 120° C., then subjected to thermogravimetric analysis (TGA) by heating at 10° C./min in air to 990° C. TGA analysis resulted in a mass loss of about 18-20%.

Resin: 48.2 g

Kaolin: 96.5 g

Initiator: 1.25 g

Gel time: ˜70 minutes

Example 4: Phenolic resin and class C fly ash were mixed at a filler to resin mix ratio of 3:1. The initiated mixture was cured in air at room temperature. Samples of the cured composite were subjected to thermogravimetric analysis (TGA) by heating at 10° C./min in air to 990° C. TGA analysis resulted in a mass loss of about 16-18%.

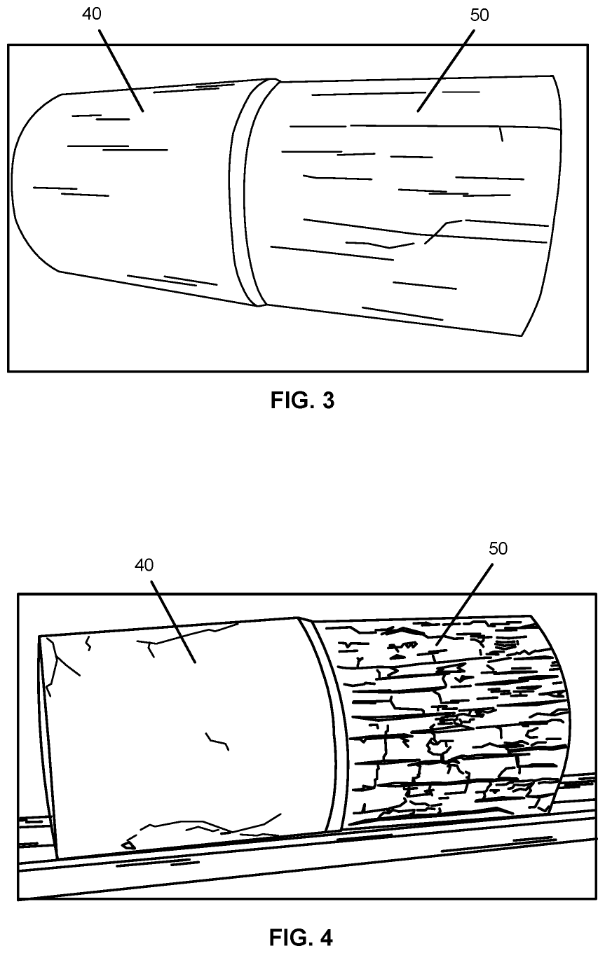

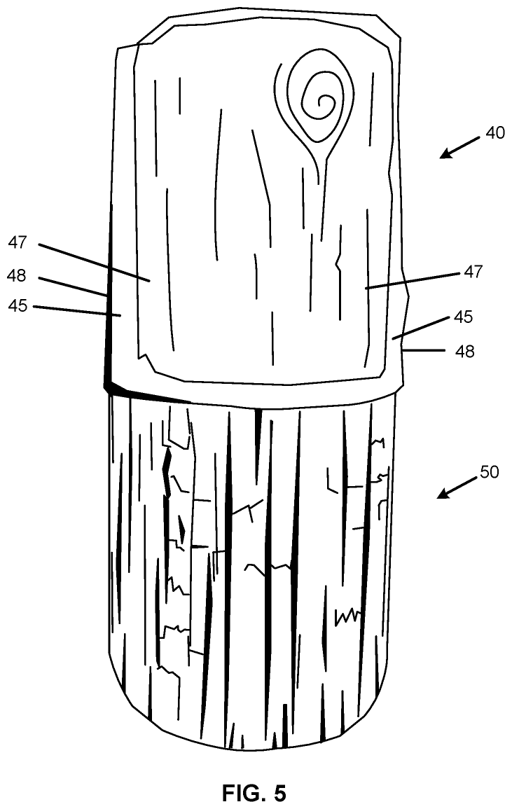

Example 5: fire performance test. An 18-inch length of a wood utility pole was coated with the coating composition of Example 1 and allowed to cure in air at room temperature. The cured composite coating had a thickness from 6 mm to 8 mm. In various tests, the coated utility pole was placed in a furnace at 1150° C. for two minutes or three minutes. After removing the sample from the furnace, the coating exhibited a surface char layer. Upon removing the coating from the wood, the underlying wood showed no signs of burning. FIG. 3 shows an example of a coated section of utility pole 40 and an uncoated section of utility pole 50, where the coating is the cured composite of Example 1. FIG. 4 is a photograph showing the coated section of utility pole 40 and the uncoated section of utility pole 50 after heating at 1150° C. for 2-3 minutes. As can be seen, the coating exhibits an outer char layer and the uncoated utility pole 50 is heavily charred. FIG. 5 is a photograph showing the coated section of utility pole 40 and the uncoated section of utility pole 50. In this photograph, part of the coating 45 has been removed to reveal the underlying wood 47. The outer surface of the coating 45 has a relatively thin (˜3 mm) char layer 48. As can be seen, the underlying wood 47 is not charred and appears undamaged by visual inspection. In contrast, the uncoated section of utility pole 50 is heavily charred.

Example 6: salt water corrosion test. Untreated steel rebar, rebar coated with epoxy, and steel rebar coated with the composition of Example 1 were all submerged in salt water for one month. The samples were removed from the water and evaluated by visual inspection. The untreated rebar showed significant corrosion (rust) and scale on the outside surface. The epoxy-coated rebar had spots of rust that penetrated the epoxy coating. The rebar coated with the composition of Example 1 was unchanged.

Example 7: termite resistance. A 4″×4″ (100 mm×100 mm) wood post coated with the composition of Example 1 and a pressure-treated wood pole of the same dimensions were placed in termite-infested soil in Florida. After one month, the pressure-treated post lost two feet (˜60 cm) of length due to termites; the composite-coated post had no visible damage.

Example 8: marine animals on wood posts in salt water. Untreated dock posts and dock posts coated with the composition of Example 1 are placed side-by-side in ocean water. After one month, the untreated wood posts are completely encrusted with marine animals and the composite-coated post has no encrustation.

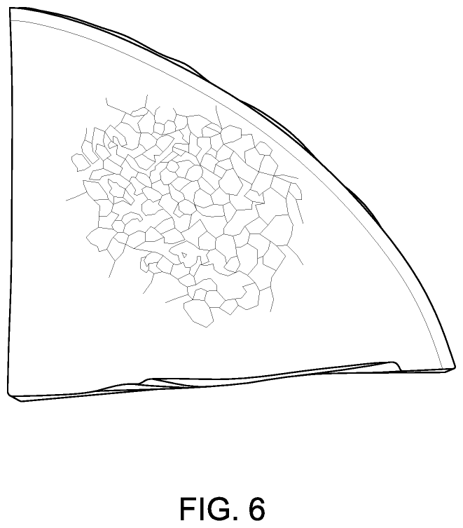

Example 9: thermal testing of a cured composite (neat). FIG. 6 is a photograph of a sample prepared by mixing dicyclopentadiene (DCPD) polyester resin with class C fly ash in a filler:binder ratio of 3:1 by weight, adding MEKP to 3% of the binder by weight. DCPD polyester resin is an unsaturated thermoset resin with low shrinkage. The initiated mixture was placed in a plastic bucket to cure in air at room temperature. The cured composite was cut into quarters using a diamond blade. The cut sample measures about 85 mm×85 mm and has a thickness of about 10 mm. The center of the sample was exposed to a propane torch for 17 minutes (flame temperature ˜1900° C.), during which time the sample was heated to and held at a temperature from 815-1000° C. After allowing the red-hot center of the sample to cool to the extent that it shed the red color, the edges of the sample were only warm to the touch and could be handled by hand. After heating with the propane torch, the region of the sample exposed to the torch exhibited a char layer having a blistered appearance and a thickness of 0.016 inch (0.36 mm), measured using a computer-controlled microscope. Based on visual inspection, the remainder of the sample appeared to be undamaged.

Example 10: thermal testing of coated OSB. OSB was coated with a 2 mm-thick layer of the composition of Example 1 and allowed to air cure to a composite. Using a torch to heat the coated face of the OSB, the temperature of the coated face of the OSB was measured at 1150° using an infrared heat gun. At the same time, the uncoated back side of the OSB measured 24° C. (the ambient temperature of the room).

### Further Example Embodiments

The following examples pertain to further embodiments, from which numerous permutations and configurations will be apparent.

Example 1 is a pre-cure ceramic mixture comprising a fire-resistant binder and an inorganic filler comprising fly ash, wherein a mix ratio of the inorganic filler to the fire-resistant binder is from 1:1 to 9:1 by weight, wherein upon curing in the presence of an oxidizing initiator at room temperature, the pre-cure ceramic mixture hardens into a composite including a continuous polymer matrix phase and distributed phase of the inorganic filler.

Example 2 includes the subject matter of Example 1, wherein the fire-resistant binder is a halogenated epoxy or a halogenated resin.

Example 3 includes the subject matter of Example 1, wherein the fire-resistant binder is selected from one of a brominated vinyl ester resin, a brominated polyester, a brominated epoxy, and a phenolic resin.

Example 4 includes the subject matter of any of Examples 1-3, wherein the mix ratio is from 1:1 to 6:1.

Example 5 includes the subject matter of Example 4, wherein the mix ratio is from 2:1 to 4:1.

Example 6 includes the subject matter of Example 4, wherein the mix ratio is from 2.5:1 to 3.5:1.

Example 7 includes the subject matter of any of Examples 1-6, wherein the inorganic filler comprises at least 95% class C fly ash by weight.

Example 8 includes the subject matter of Example 7, wherein the fire-resistant binder is a halogenated vinyl ester resin, the inorganic filler includes class C fly ash in an amount of at least 95% by weight of the inorganic filler, and the mix ratio is from 2.5:1 to 3.5:1.

Example 9 includes the subject matter of any of Examples 1-8, wherein the filler consists essentially of fly ash.

Example 10 includes the subject matter of any of Examples 1-8, wherein the inorganic filler comprises fly ash.

Example 11 includes the subject matter of Example 10, wherein the inorganic filler further comprises one or more additives selected from talc, kaolin, mullite, and bottom ash.

Example 12 includes the subject matter of Example 11, wherein the one or more additives are present in an amount of 40% or less by weight of a total weight of the inorganic filler.

Example 13 includes the subject matter of Example 11, wherein the one or more additives are present in an amount of 20% or less by weight of the total weight of the inorganic filler.

Example 14 includes the subject matter of Example 11, wherein the one or more additives are present in an amount of 10% or less by weight of the total weight of the inorganic filler.

Example 15 includes the subject matter of Example 1, wherein the fire-resistant binder is a halogenated vinyl ester resin, the inorganic filler includes class C fly ash in an amount of at least 95% by weight of the inorganic filler, and the mix ratio is from 2.5:1 to 3.5:1.

Example 16 includes the subject matter of Example 1, wherein the fire-resistant binder is a halogenated vinyl ester resin, the inorganic filler includes kaolin in an amount of at least 95% by weight of the inorganic filler, and wherein the mix ratio is from 1:1 to 2.5:1.

Example 17 includes the subject matter of Example 1, wherein the fire-resistant binder is a phenolic resin, the inorganic filler includes class C fly ash in an amount of at least 95% by weight of the inorganic filler, and the mix ratio is from 2.5:1 to 3.5:1.

Example 18 is a coated article comprising a cellulose-based substrate and a coating on at least one surface of the substrate, the coating comprising calcium, aluminum, silicon, and oxygen.

Example 19 includes the subject matter of Example 18, wherein the coating is a refractory ceramic.

Example 20 includes the subject matter of Example 18, wherein the coating is a composite including a continuous polymer matrix and an inorganic filler distributed in the polymer matrix.

Example 21 includes the subject matter of Example 20, wherein the polymer matrix comprises one or more of styrene, phenol, and formaldehyde.

Example 22 includes the subject matter of any of Examples 18-21, wherein the coating further comprises one or more of iron, magnesium, nickel, phosphorous, potassium, sulfur, titanium, and vanadium.

Example 23 includes the subject matter of any of Examples 18-22, wherein the coating further comprises hydrogen.

Example 24 includes the subject matter of any of Examples 18-23, wherein the substrate comprises wood.

Example 25 includes the subject matter of Example 24, wherein the substrate is in a form of a sheet.

Example 26 includes the subject matter of Example 24, wherein the substrate is a sheet of oriented strand board.

Example 27 includes the subject matter of Example 24, wherein the substrate is a wooden pole.

Example 28 includes the subject matter of any of Examples 18-27, wherein the coating has a coefficient of thermal conductivity from 0.1 to 0.5 W/mK at 25° C.

Example 29 includes the subject matter of any of Examples 18-28, wherein the coating has a melting point above 1150° C.

Example 30 includes the subject matter of any of Examples 18-29, wherein the coating has a thickness from 1 mm to 6 mm.

Example 31 includes the subject matter of any of Examples 18-30, wherein the coating is a first coating, the coated article further comprising a layer of a second coating on the layer of the first coating.

Example 32 includes the subject matter of Example 31, wherein the first coating is compositionally distinct from the second coating.

Example 33 includes the subject matter of Example 32, wherein the first coating comprises styrene and the second coating comprises phenol and/or formaldehyde.

Example 34 includes the subject matter of any of Examples 18-33 wherein the coating comprises an outer char layer.

Example 35 is a method of coating a substrate, the method comprising providing a substrate to be coated; providing a pre-cure ceramic mixture comprising an inorganic filler and a fire-resistant epoxy or resin, the pre-cure ceramic mixture having a mix ratio of filler to binder from 1:1 to 9:1; admixing an initiator with the pre-cure ceramic mixture to form an initiated mixture having a gel time; applying a layer of the initiated mixture on a surface of at least a portion of the substrate prior to expiration of the gel time so that the initiated mixture wets the substrate; and curing the initiated mixture in situ to form a layer of cured composite on the substrate.

Example 36 includes the subject matter of Example 35 and further comprises providing an initiated second pre-cure ceramic mixture, the second pre-cure ceramic mixture comprising a second inorganic filler and a fire-resistant resin or epoxy; and applying a layer of the initiated second pre-cure ceramic mixture on the layer of cured composite; and curing the initiated second pre-cure ceramic mixture in situ.

Example 37 includes the subject matter of Example 36 and further comprises selecting the inorganic filler to include at least 50% fly ash by weight; and selecting the second inorganic filler to include at least 50% kaolin by weight.

Example 38 includes the subject matter of Example 36 and further comprises selecting the pre-cure ceramic mixture and the second pre-cure ceramic mixture to be compositionally distinct.

Example 39 includes the subject matter of any of Examples 35-38 and further comprises selecting the pre-cure ceramic mixture having the inorganic filler comprising at least 95% fly ash by weight.

Example 40 includes the subject matter of any of Examples 35-39, wherein the inorganic filler consists essentially of fly ash.

Example 41 includes the subject matter of any of Examples 35-38 and further comprises selecting the pre-cure ceramic mixture having the inorganic filler comprising at least 50% kaolin by weight.

Example 42 includes the subject matter of any of Examples 35-41, wherein curing is performed at a temperature from 100° C. to 200° C. in an oxygen-free atmosphere.

Example 43 includes the subject matter of any of Examples 35-42 and further comprises, after curing the initiated mixture, heat treating the cured composite in situ at a temperature from 100° C. to 300° C.

Example 44 includes the subject matter of any of Examples 35-43 and further comprises, after curing the initiated mixture, heating the cured composite in situ at a temperature of at least 800° C.

Example 45 includes the subject matter of Example 44 wherein the temperature is at least 900° C.

Example 46 includes the subject matter of Example 44, wherein the temperature is at least 1000° C.

Example 47 includes the subject matter of Example 44, wherein the temperature is at least 1100° C.

Example 48 includes the subject matter of Example 44, wherein the temperature is at least 1150° C.

Example 49 includes the subject matter of any of Examples 35-48, wherein the substrate to be coated comprises wood.

Example 50 includes the subject matter of Example 49, wherein the substrate to be coated comprises a wooden utility pole.

Example 51 includes the subject matter of Example 50, wherein the applying the layer of the initiated mixture includes extruding the initiated mixture to form a ribbon and wrapping the wooden utility pole with the ribbon of the initiated mixture.

Example 52 includes the subject matter of Example 49, wherein the substrate to be coated comprises a sheet of engineered wood.

Example 53 includes the subject matter of Example 52, wherein the engineered wood is oriented strand board (OSB).

Example 54 includes the subject matter of Example 52, wherein the engineered wood is medium densify fiberboard (MDF).

Example 55 includes the subject matter of Example 49, wherein the substrate to be coated is a sheet of plywood.

Example 56 includes the subject matter of any of Examples 35-48, wherein the substrate to be coated comprises metal.

Example 57 includes the subject matter of Example 56, wherein the substrate to be coated comprises steel rebar.

In use, a ceramic coating in accordance with the present disclosure can be used to make products such as synthetic timbers. For example, the present disclosure contemplates certain products such as synthetic timbers for a timber-frame home or log cabin, where the ceramic part is a siding product that mimics the timber component (e.g., a half-log component). For example, the synthetic timber is approximately 10 inches in width and 12 to 16 ft in length. The half-log is 24 inches in diameter and can be any length to mimic the large logs that are critical for the desired look of an expensive log home.

Both timbers and half-logs can be spaced a couple inches apart so “chinking” can be inserted between the timbers or logs for a “pioneer” look. When attached to the outside sheathing of the home it becomes an exact replica of a full timber home. Similarly, the half-log can be made entirely from the ceramic material. Once the half-log is affixed to the outside of the sheathing, one cannot tell the difference from a true log cabin because the inside of the wall is not visible. In this manner, it is possible to place synthetic timbers or logs on the exterior of the building as an exact replica of a true timber-frame or log home. The ceramic does not require any maintenance for the lifetime of the home, it is very lightweight while being very strong. It has the potential to reduce the cost of the home substantially. Additional advantages include providing the look of a real timber home, dramatically increasing the longevity, (zero maintenance), and reduced cost compared to a timber home. The additive used to lower the weight without affecting the fire resistance or the structural integrity, is Perlite which is a volcanic rock found in the USA at a cost of about $50 a ton. The low cost of this material fits perfectly with the cost of the fly ash allowing one produce true look-alikes for wood-grained timbers and logs that appear to be 100 years old and deeply weathered; however, there is no wood in them, they are all synthetic made from Ceramic and Perlite (rice grain size). Also, the products are far lighter than the traditional wet wood. The perlite is a much lower weight material that can extract more than 50% of the weight of a synthetic log or timber, and they're fire resistant to 2100 degrees F.

The foregoing description of example embodiments has been presented for the purposes of illustration and example. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

1-34. (canceled)

35. A method of coating a substrate, the method comprising:
providing a substrate to be coated;
providing a pre-cure ceramic mixture comprising an inorganic filler and a fire-resistant epoxy or resin, the pre-cure ceramic mixture having a mix ratio of filler to binder from 1:1 to 9:1;
admixing an initiator with the pre-cure ceramic mixture to form an initiated mixture having a gel time;
applying a layer of the initiated mixture on a surface of at least a portion of the substrate prior to expiration of the gel time so that the initiated mixture wets the substrate; and
curing the initiated mixture in situ to form a layer of cured composite on the substrate.

36. The method of claim 35 further comprising:
providing an initiated second pre-cure ceramic mixture, the second pre-cure ceramic mixture comprising a second inorganic filler and a fire-resistant resin or epoxy;
applying a layer of the initiated second pre-cure ceramic mixture on the layer of cured composite; and curing the initiated second pre-cure ceramic mixture in situ.

37. The method of claim 36 further comprising:
selecting the inorganic filler to include at least 50% fly ash by weight; and
selecting the second inorganic filler to include at least 50% kaolin by weight.

38. The method of claim 36 further comprising selecting the pre-cure ceramic mixture and the second pre-cure ceramic mixture to be compositionally distinct.

39. The method of claim 35 further comprising:
selecting the pre-cure ceramic mixture having the inorganic filler comprising at least 95% fly ash by weight.

40. The method of claim 35, wherein the inorganic filler consists essentially of fly ash.

41. The method of claim 35 further comprising:
selecting the pre-cure ceramic mixture having the inorganic filler comprising at least 50% kaolin by weight.

42. The method of claim 35, wherein curing is performed at a temperature from 100° C. to 200° C. in an oxygen-free atmosphere.

43. The method of claim 35 further comprising, after curing the initiated mixture, heat treating the cured composite in situ at a temperature from 100° C. to 300° C.

44. The method of claim 35 further comprising, after curing the initiated mixture, heating the cured composite in situ at a temperature of at least 800° C.

45. The method of claim 44 wherein the temperature is at least 900° C.

46. The method of claim 44, wherein the temperature is at least 1000° C.

47. The method of claim 44, wherein the temperature is at least 1100° C.

48. The method of claim 44, wherein the temperature is at least 1150° C.

49. The method of any of claims 35-48, wherein the substrate to be coated comprises wood.

50. The method of claim 48, wherein the substrate to be coated comprises a wooden utility pole.

51. The method of claim 48, wherein the applying the layer of the initiated mixture includes extruding the initiated mixture to form a ribbon and wrapping the wooden utility pole with the ribbon of the initiated mixture.

52. The method of claim 49, wherein the substrate to be coated is selected from a sheet of medium density fiberboard (MDF), a sheet of oriented strand board (OSB), or a sheet of plywood.

53-57. (canceled)
